(19) United States
(12) Patent Application Publication
(10) Pub. No.: US 2026/0130810 A1
(43) Pub. Date: May 14, 2026

(54) LIFTING DEVICE AND VIBRATION PLATE

(71) Applicant: Xiamen Renhe Sports Equipment Co.,Ltd., Xiamen (CN)

(72) Inventor: Yangjie Ren, Xiamen (CN)

(73) Assignee: Xiamen Renhe Sports Equipment Co.,Ltd., Xiamen, FJ (CN)

(21) Appl. No.: 19/023,425

(22) Filed: Jan. 16, 2025

(30) Foreign Application Priority Data
Nov. 14, 2024 (CN) 2024227901725

(51) Int. Cl. A61H 1/00; A61H 23/02

(52) U.S. Cl. CPC A61H 1/005; A61H 23/0254; A61H 2201/149; A61H 2201/1664

(57) ABSTRACT

A lifting device and a vibration plate are provided, and belong to the field of fitness equipment. The lifting device includes: a mounting base, a lifting assembly, a transmission assembly, a driving assembly, and a lifting base. The transmission assembly includes an eccentric part, a first connecting rod, and a second connecting rod. The driving assembly drives the eccentric part to rotate. The eccentric part drives the second connecting rod to move. The movement of second connecting rod drives the movement of first connecting rod, so that positions of free ends of the rocker lifting mechanisms connected to the first connecting rod and the second connecting rod change, and the lifting base hinged to fixed ends of the rocker lifting mechanisms rises and falls in a reciprocating manner relative to the mounting base. The lifting device has a simple connection structure, is stable in transmission, and has low assembling difficulty.

### TECHNICAL FIELD

The present disclosure relates to the field of fitness equipment, and in particular, to a lifting device and a vibration plate.

### BACKGROUND

With acceleration of modern pace of life and increase of work stress, people are paying more and more attention to health and exercise. As a set of emerging fitness equipment, a vibration plate has gradually attracted the attention. The vibration plate is a fitness machine that uses a lifting mechanism to make a lifting platform rise and fall at a high frequency. The vibration plate simulates natural vibrations of users generated during walking or running of the users, so that the users feel they are running.

A vertical vibration plate generates vibrations perpendicular to the ground by making a movable top frame move linearly with respect to a supporting bottom frame. This vibration can trigger muscle contraction stimulation throughout the body, thus achieving an effect of repeated exercise training, and having a significant training effect on bone density, muscle strengthening, blood circulation system, and other aspects. By simulating rope skipping, the vertical vibration plate can achieve an effect of general movement from bottom to top and from outside to inside, which has many benefits in enhancing health, including strengthening bone mass, preventing osteoporosis, reducing weight, shaping, and the like. Therefore, there is an urgent need for a vibration plate with a simple structure and stable transmission.

### SUMMARY

The present disclosure provides a lifting device and a vibration plate. It is in an urgent need for a vibration plate with a simple structure and stable transmission in the prior art. The technical solution is as follows:

According to an aspect of the present disclosure, a lifting device is provided, including a mounting base, a lifting assembly, a transmission assembly, a driving assembly, and a lifting base, wherein
the lifting assembly is mounted on the mounting base, and the lifting assembly includes two rocker lifting mechanisms arranged oppositely;
the transmission assembly is located between the two rocker lifting mechanisms; the transmission assembly includes an eccentric part, a first connecting rod, and a second connecting rod; two ends of the first connecting rod are respectively hinged to the two rocker lifting mechanisms; one end of the second connecting rod is connected to the eccentric part, and the other end of the second connecting rod is hinged to one of the two rocker lifting mechanisms;
the driving assembly is connected to the eccentric part;
the lifting base is connected to the lifting assembly on the side away from the mounting base;
the driving assembly drives the eccentric part to rotate; and the eccentric part drives and the lifting assembly to rise and fall through the transmission assembly, so that the lifting assembly drives the lifting base to rise and fall relative to the mounting base.

Optionally, any one of the first connecting rod includes a frame and a reinforcing rib; two ends of the frame are respectively hinged to the two rocker lifting mechanisms; and the reinforcing rib is fixedly connected to an inner side of the frame.

Optionally, the transmission assembly includes two first connecting rods and two second connecting rods; the two rocker lifting mechanisms in the lifting assembly are arranged in a first direction;
the two second connecting rods are arranged oppositely in a second direction; the second direction is perpendicular to the first direction; the two second connecting rods are respectively adjacent to the two first connecting rods; and ends of the two second connecting rods away from the eccentric part are hinged to the two rocker lifting mechanisms, respectively.

Optionally, the eccentric part includes a first cam portion, a connecting portion, and a second cam portion; the connecting portion is fixedly connected to the first cam portion and the second cam portion, respectively;
the first cam portion is hinged to one of the two second connecting rods; the second cam portion is hinged to the other second connecting rod; and
when the eccentric part rotates, a deflection displacement direction of the first cam portion is opposite to a deflection displacement direction of the second cam portion.

Optionally, the two second connecting rods in any one of transmission assembly are located between the two first connecting rods.

Optionally, any one of the rocker lifting mechanism includes a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

Optionally, the lifting device includes two groups of lifting assemblies and two groups of transmission assemblies;
the two groups of lifting assemblies are respectively located on two sides of the driving assembly; the two groups of transmission assemblies are respectively located on two sides of the driving assembly; the two groups of lifting assemblies are in one-to-one correspondence to the two groups of transmission assemblies; and the lifting assemblies are hinged to the corresponding transmission assemblies.

According to another aspect of the present disclosure, a vibration plate is provided, including an equipment housing and a lifting device located in the equipment housing, wherein the lifting device includes the above lifting device;
the equipment housing includes a first housing and a second housing; the first housing and the mounting base are fixedly connected to each other or are of an integrated structure; and the second housing and the lifting base are fixedly connected to each other or are of an integrated structure.

Optionally, the vibration plate further includes a pull rope connecting portion; a mounting slot is arranged in one side of the first housing facing away from the second housing;
the pull rope connecting portion is mounted in the mounting slot; the pull rope connecting portion is movably connected to the first housing; and the pull rope connecting portion extends or retracts from the mounting slot.

Optionally, the vibration plate further includes a limiting terminal, wherein the pull rope connecting portion has a connection through hole and a strip-shaped limiting through hole; the connection through hole is used for threading a pull rope;
the limiting terminal is arranged in the strip-shaped limiting through hole in a penetrating manner, and the limiting terminal is fixedly connected to the first housing; and the pull rope connecting portion extends out of or retracts into the mounting slot in a lengthwise direction of the strip-shaped limiting through hole.

Optionally, the first housing further has an elastic protrusion located in the mounting slot;
the pull rope connecting portion has a first groove and a second groove; the first groove and the second groove are arranged in the lengthwise direction of the strip-shaped limiting through hole;
when the pull rope connecting portion extends out of the mounting slot, the elastic protrusion is located in the first groove; and when the rope connecting part retracts into the mounting slot, the elastic protrusion is located in the second groove.

The technical solutions provided by the embodiments of the present disclosure bring the following beneficial effects:

A lifting device is provided, including a mounting base, a lifting assembly, a transmission assembly, a driving assembly, and a lifting base. The transmission assembly is located between two rocker lifting mechanisms of the lifting assembly. The transmission assembly includes an eccentric part, a first connecting rod, and a second connecting rod. The eccentric part is driven to rotate by the driving assembly. The eccentric part drives the second connecting rod to move. When the second connecting rod moves, the first connecting rod is driven to move, so that positions of free ends of the rocker lifting mechanisms connected to the first connecting rod and the second connecting rod change, and the lifting base hinged to fixed ends of the rocker lifting mechanisms rises and falls in a reciprocating manner relative to the mounting base. The lifting device has a simple connection structure, is stable in transmission, and has low assembling difficulty. It is conductive to reducing the production costs of a production enterprise, improving the production efficiency, and reducing the equipment fault rate.

### BRIEF DESCRIPTION OF THE DRAWINGS

To describe the technical solutions in the embodiments of the present disclosure more clearly, the following briefly introduces the accompanying drawings for describing the embodiments. Obviously, the accompanying drawings in the following description show merely some embodiments of the present disclosure, and a person of ordinary skill in the art may still derive other drawings from the accompanying drawings without creative efforts.

FIG. 1 is a schematic structural diagram of a lifting device according to an embodiment of the present disclosure;

FIG. 2 is a schematic structural exploded view of the lifting device shown in FIG. 1;

FIG. 3 is a schematic structural diagram of lifting assemblies and transmission assemblies in the lifting device shown in FIG. 1;

FIG. 4 is a schematic structural diagram of another kind of lifting assemblies and another kind of transmission assemblies according to an embodiment of the present disclosure;

FIG. 5 is a schematic structural diagram of another kind of lifting assemblies and another kind of transmission assemblies according to an embodiment of the present disclosure;

FIG. 6 is a schematic structural exploded view of a transmission assembly according to an embodiment of the present disclosure;

FIG. 7 is a schematic diagram of a connection structure of a rocker lifting mechanism according to an embodiment of the present disclosure;

FIG. 8 is a schematic structural diagram of a vibration plate according to an embodiment of the present disclosure;

FIG. 9 is a schematic structural exploded view of the vibration plate shown in FIG. 8;

FIG. 10 is a schematic structural diagram of another vibration plate according to an embodiment of the present disclosure; and

FIG. 11 is a schematic structural exploded view of the vibration plate shown in FIG. 10.

### DETAILED DESCRIPTION OF THE INVENTION

To make the objectives, technical solutions, and advantages of the present disclosure clearer, the following further describes implementations of the present disclosure in detail with reference to the accompanying drawings.

Although the present disclosure can be easily manifested in different forms of embodiments, only some specific embodiments are shown in the accompanying drawings and will be explained in detail in this specification. Meanwhile, it can be understood that this specification should be regarded as an exemplary explanation of the principle of the present disclosure, rather than being intended to limit the present disclosure to what is explained here.

Therefore, a feature pointed out in this specification will be used to explain one of the features of an embodiment of the present disclosure, rather than implying that each embodiment of the present disclosure needs to have the described feature. Furthermore, it should be noted that this specification describes many features. Although some features can be combined to demonstrate possible system designs, these features can also be used for other combinations that are not explicitly stated. Therefore, unless otherwise specified, the combination described is not intended for limitation.

In the embodiments shown in the drawings, directional indications (such as up, down, left, right, front, and back) are used to explain that the structures and motions of various components of the present disclosure are not absolute but relative. When these components are in positions shown in the accompanying drawings, these explanations are appropriate. If the explanations for the positions of these components change, the indications for these directions also change correspondingly.

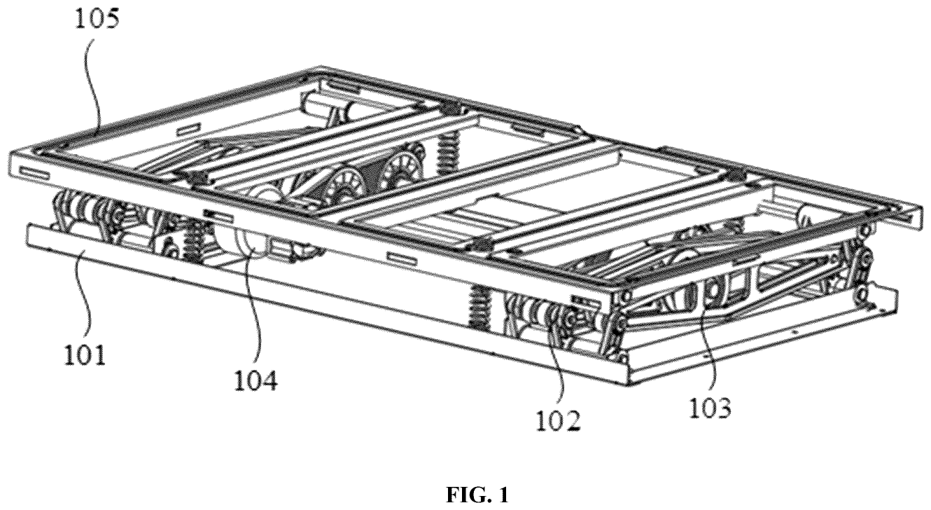

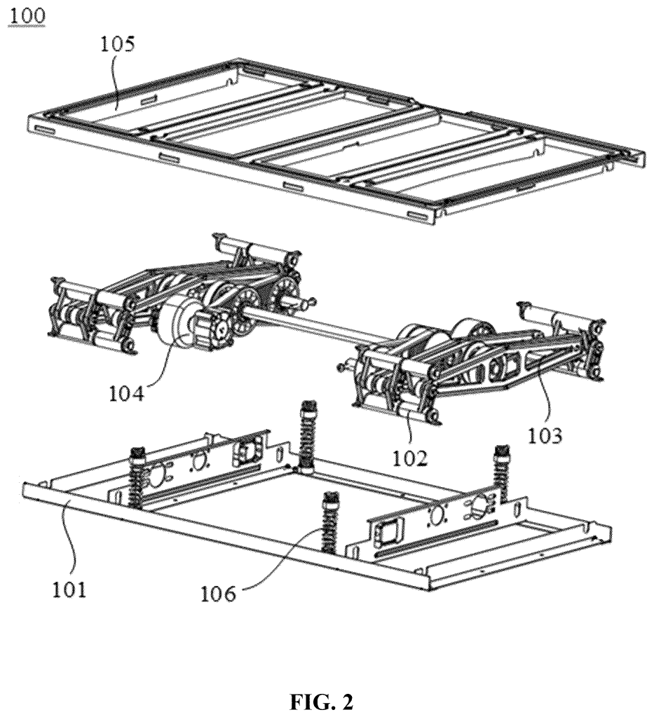

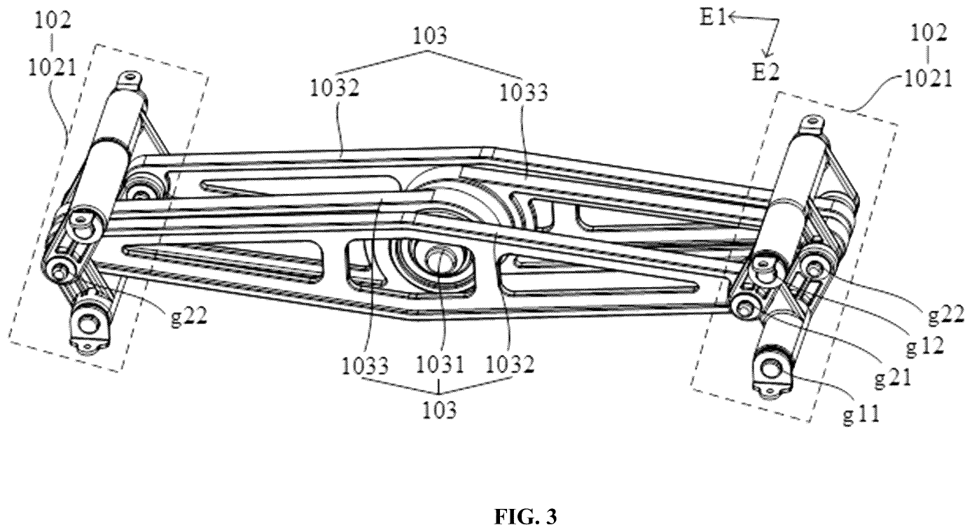

Referring to FIG. 1, FIG. 2, and FIG. 3, FIG. 1 is a schematic structural diagram of a lifting device 100 according to an embodiment of the present disclosure. FIG. 2 is a schematic structural exploded view of the lifting device 100 shown in FIG. 1. FIG. 3 is a schematic structural diagram of lifting assemblies 102 and transmission assemblies 103 in the lifting device 100 shown in FIG. 1. The lifting device 100 can include a mounting base 101, lifting assemblies 102, transmission assemblies 103, a driving assembly 104, and a lifting base 105.

The lifting assemblies 102 can be mounted on the mounting base 101, and the lifting assemblies 102 can be hinged to the mounting base 101. Each lifting assembly 102 can include two rocker lifting mechanisms 1021 arranged opposite to each other in a first direction E1. Each rocker lifting mechanism 1021 can have two opposite fixed ends g11 and g12 in a direction perpendicular to the ground. The two opposite fixed ends g11 and g12 of the rocker lifting mechanism 1021 can be hinged to the mounting base 101 and the lifting base 105, respectively. Each rocker lifting mechanism 1021 can have two opposite free ends g21 and g22 in a direction parallel to the ground. At least one of the two free ends g21 and g22 of the rocker lifting mechanism 1021 can be connected to the driving assembly 104 through each transmission assembly 103 and achieve transmission.

Each transmission assembly 103 can be located between the two rocker lifting mechanisms 1021 of the corresponding lifting assembly 102. Each transmission assembly 103 can include an eccentric part 1031, first connecting rods 1032, and second connecting rods 1033. Two ends of the first connecting rods 1032 are respectively hinged to the two rocker lifting mechanisms 1021. One end of each second connecting rod 1033 is connected to the eccentric part 1031, and the other end of the second connecting rod 1033 is hinged to one of the two rocker lifting mechanisms 1021. Exemplarily, each lifting assembly 102 has a first free end g21 and second a free end g22. One end of each first connecting rod 1032 is hinged to the first free end g21 of one of the two rocker lifting mechanisms 1021, and the other end is hinged to the second free end g22 of the other rocker lifting mechanism 1021. Two ends of the second connecting rod 1033 are respectively hinged to the eccentric part 1031 and the second free end g22 of one of the two rocker lifting mechanisms 1021.

The driving assembly 104 can be connected to each eccentric part 1031 to drive the eccentric part 1031 to rotate. The lifting base 105 is connected to one side of each lifting assembly 102 facing away from the mounting base 101. The driving assembly 104 can drive each eccentric part 1031 to rotate, and the eccentric part 1031 drives the lifting assemblies 102 to rise and fall through the transmission assembly 103, so that the lifting assemblies 102 drive the lifting base 105 to rise and fall relative to the mounting base 101.

Exemplarily, when the driving assembly 104 drives the eccentric part 1031 to rotate, the eccentric part 1031 can drive the second connecting rods 1033 to move in the first direction E1. The second connecting rods 1033 drive the second free ends g22 of the rocker lifting mechanisms 1021 to move in the first direction E1. Meanwhile, the second free ends g22 of the rocker lifting mechanisms 1021 drive the first free ends g21 of the other rocker lifting mechanisms 1021 to move in the first direction E1 through the first connecting rods 1032.

Moreover, the lifting device 100 can further include a plurality of connecting bearings. The eccentric part 1031 can be connected to the second connecting rods 1033 through the connecting bearings. Since the eccentric part 1031 can only be connected to the second connecting rods 1033, instead of being connected to the first connecting rods 1032. It can simplify the structure of the eccentric part 1031 and a connection structure between the eccentric part 1031 and the second connecting rods 1033. It can further reduce the number of connecting bearings used and lower the assembling difficulty of the lifting device 100.

In summary, the embodiments of the present disclosure provide a lifting device 100, including a mounting base 101, lifting assemblies 102, transmission assemblies 103, a driving assembly 104, and a lifting base 105. Each transmission assembly 103 is located between two rocker lifting mechanisms 1021 of the corresponding lifting assembly 102. Each transmission assembly 103 includes an eccentric part 1031, first connecting rods 1032, and second connecting rods 1033. The eccentric part 1031 is driven to rotate by the driving assembly 104. The eccentric part 1031 drives the second connecting rods 1033 to move. When the second connecting rods 1033 move, the first connecting rods 1032 are driven to move, so that positions of free ends g21 and g22 of the rocker lifting mechanisms 1021 connected to the first connecting rods 1032 and the second connecting rods 1033 change, and the lifting base 105 hinged to fixed ends g11 and g12 of the rocker lifting mechanisms 1021 rises and falls in a reciprocating manner relative to the mounting base 101. The lifting device 100 has a simple connection structure, is stable in transmission, and has low assembling difficulty. It is conductive to reducing the production costs of a production enterprise, improving the production efficiency, and reducing the equipment fault rate.

Referring to FIG. 1, FIG. 2, and FIG. 3, each transmission assembly 103 includes two first connecting rods 1032 and two second connecting rods 1033. The two first connecting rods 1032 are arranged opposite to each other in a second direction E2. The second direction E2 is perpendicular to a first direction E1. The two second connecting rods 1033 are respectively arranged adjacent to the two first connecting rods 1032, and two ends of any first connecting rod 1032 are respectively hinged to the two rocker lifting mechanisms 1021. One end of each of the two second connecting rods 1033 is connected to the eccentric part 1031, and the other end of each of the two second connecting rods 1033 away from the eccentric part 1031 is hinged to each of the two rocker lifting mechanisms 1021. Namely, two ends of one of the two second connecting rods 1033 are respectively hinged to the eccentric part 1031 and one of the rocker lifting mechanisms 1021, and two ends of the other second connecting rod 1033 are respectively hinged to the eccentric part 1031 and the other rocker lifting mechanism 1021. The two first connecting rods 1032 and the two second connecting rods 1033 can be in one-to-one correspondence, and each second connecting rod 1033 is adjacent to the corresponding first connecting rod 1032.

Exemplarily, any lifting assembly 102 has a first free end g21 and a second free end g22. One end of any first connecting rod 1032 is hinged to the first free end g21 of one of the two rocker lifting mechanisms 1021, and the other end is hinged to the second free end g22 of the other rocker lifting mechanism 1021. Two ends of one of the two second connecting rods 1033 are respectively hinged to the eccentric part 1031 and the second free end g22 of one of the two rocker lifting mechanisms 1021. Two ends of the other second connecting rod 1033 are respectively hinged to the eccentric part 1031 and the second free end g22 of the other rocker lifting mechanism 1021.

Exemplarily, a transmission process of a group of the first connecting rod 1032 and the second connecting rod 1033 is taken as an example. When the driving assembly 104 drives the eccentric part 1031 to rotate, the eccentric part 1031 can drive the second connecting rods 1033 to move in the first direction E1. The second connecting rod 1033 drives the second free end g22 of the corresponding rocker lifting mechanism 1021 to move in the first direction E1. Meanwhile, the second free end g22 of the rocker lifting mechanism 1021 drives the first free end g21 of the other rocker lifting mechanism 1021 to move in the first direction E1 through the first connecting rod 1032. The other group of the first connecting rod 1032 and the second connecting rod 1033 has the same movement process as the above group of the first connecting rod 1032 and the second connecting rod 1033, and has an opposite movement direction to the movement direction of the above group of the first connecting rod 1032 and the second connecting rod 1033. In this way, the eccentric part 1031 is driven by the driving assembly 104 to rotate. The eccentric part 1031 drives the two second connecting rods 1033 to move. When the two second connecting rods 1033 move, the two first connecting rods 1032 are driven to move, so that positions of the two free ends g21 and g22 of the rocker lifting mechanisms 1021 connected to the first connecting rods 1032 and the second connecting rods 1033 change, and the lifting base 105 hinged to the fixed ends g12 of the rocker lifting mechanisms 1021 move up and down relative to the mounting base 101. In this way, the stability of connection between the transmission assemblies 103 and the lifting assemblies 102 can be improved, which can make the entire structure rise and fall more steadily.

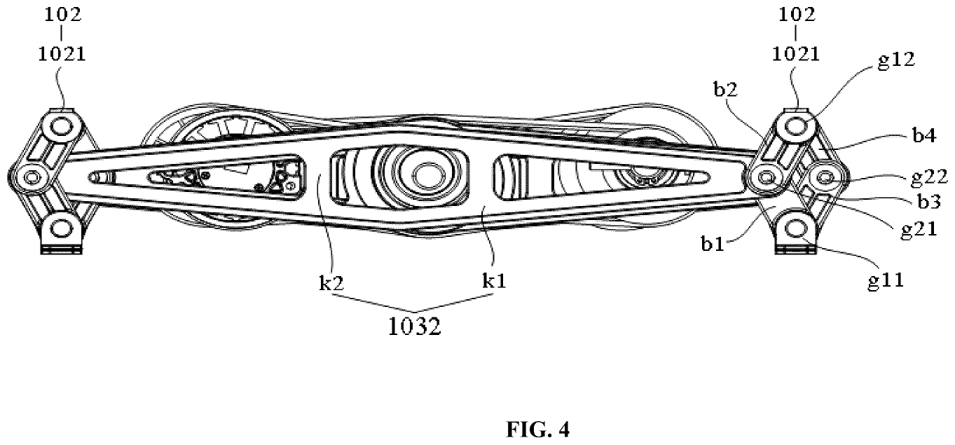

Referring to FIG. 4, FIG. 4 is a schematic structural diagram of another kind of lifting assemblies 102 and another kind of transmission assemblies 103 according to an embodiment of the present disclosure. In an optional implementation, each first connecting rod 1032 can include a first portion and a second portion which are arranged in a first direction E1. One end of the first portion away from the second portion is hinged to one of the two rocker lifting mechanisms 1021, and the other end of the second portion away from the first portion is hinged to the other rocker lifting mechanism 1021. The first portion and the second portion are of an integrated structure. In this way, two lifting assemblies 102 can be connected through the first connecting rod 1032. The two lifting assemblies 102 can be linked to move synchronously, and the structural strength and structural stability of the transmission assemblies 103 can be improved.

In an optional implementation, each first connecting rod 1032 can include a frame k1 and a reinforcing rib k2. Two ends of the frame k1 are respectively hinged to the two rocker lifting mechanisms 1021; and the reinforcing rib k2 is fixedly connected to an inner side of the frame k1. Since a length of each first connecting rod 1032 is greater than a length of each second connecting rod 1033, the reinforcing rib k2 is arranged in the first connecting rod 1032, which can enhance the strength of the first connecting rod 1032 and improve the overall stability of the transmission assembly 103. The frame k1 can be diamond-shaped, and there may be one, two, three, or more reinforcing ribs k2.

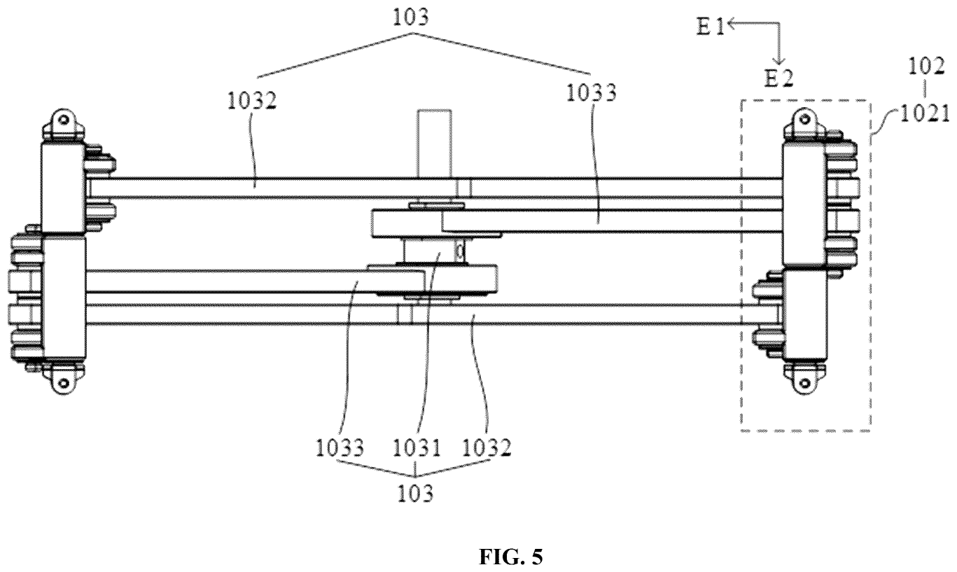

Referring to FIG. 5, FIG. 5 is a schematic structural diagram of another kind of lifting assemblies 102 and another kind of transmission assemblies 103 according to an embodiment of the present disclosure. In an optional implementation, two second connecting rods 1033 in any transmission assembly 103 can be located between two first connecting rods 1032. The two second connecting rods 1033 are arranged between the two first connecting rods 1032, which can shorten a distance between the two second connecting rods 1033, thereby reducing a size of the eccentric part 1031 connected to the two second connecting rods 1033 and improving the stability of connection between the two second connecting rods 1033 and the eccentric part 1031.

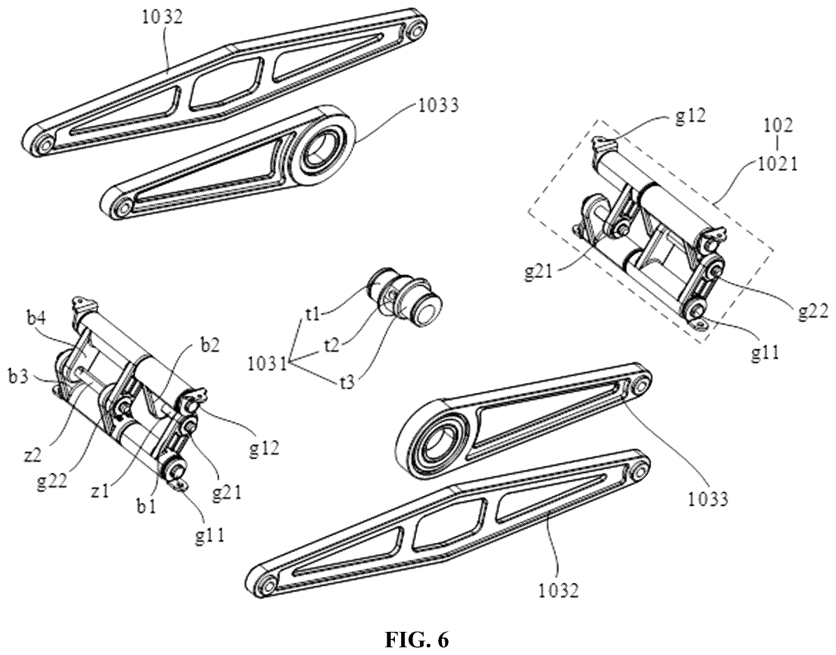

Referring to FIG. 6, FIG. 6 is a schematic structural exploded view of a transmission assembly 103 according to an embodiment of the present disclosure. In an optional implementation, the eccentric part 1031 can include a first cam portion t1, a connecting portion t2, and a second cam portion t3. The connecting portion t2 is fixedly connected to the first cam portion t1 and the second cam portion t3, respectively. Or, the first cam portion t1, the connecting portion t2, and the second cam portion t3 may be of an integrated structure. The first cam portion t1 can be hinged to one of the two second connecting rods 1033, and the second cam portion t3 can be hinged to the other second connecting rod 1033. When the eccentric part 1031 rotates, a deflection displacement direction of the first cam portion t1 is opposite to a deflection displacement direction of the second cam portion t3. In this embodiment of the present disclosure, the eccentric part 1031 can be referred to as an eccentric cam. Since the deflection displacement direction of the first cam portion t1 is opposite to the deflection displacement direction of the second cam portion t3, displacement directions of the two second connecting rods 1033 connected to the first cam portion t1 and the second cam portion t3 are opposite, which can cause the two second connecting rods 1033 to respectively drive the second free ends g22 of the two rocker lifting mechanisms 1021 to move in opposite directions and cause the two first connecting rods 1032 to link the first free ends g21 of the two rocker lifting mechanisms 1021 to move in opposite directions, and movement directions of the first free end g21 and the second free end g22 of any rocker lifting mechanism 1021 are opposite. In this way, the rotation of the eccentric part 1031 can drive the two rocker lifting mechanisms 1021 to rise and fall in a reciprocating manner.

The driving assembly 104 can include a driving motor and an output shaft. The output shaft can be connected to the eccentric parts 1031 to drive the eccentric parts 1031 to rotate.

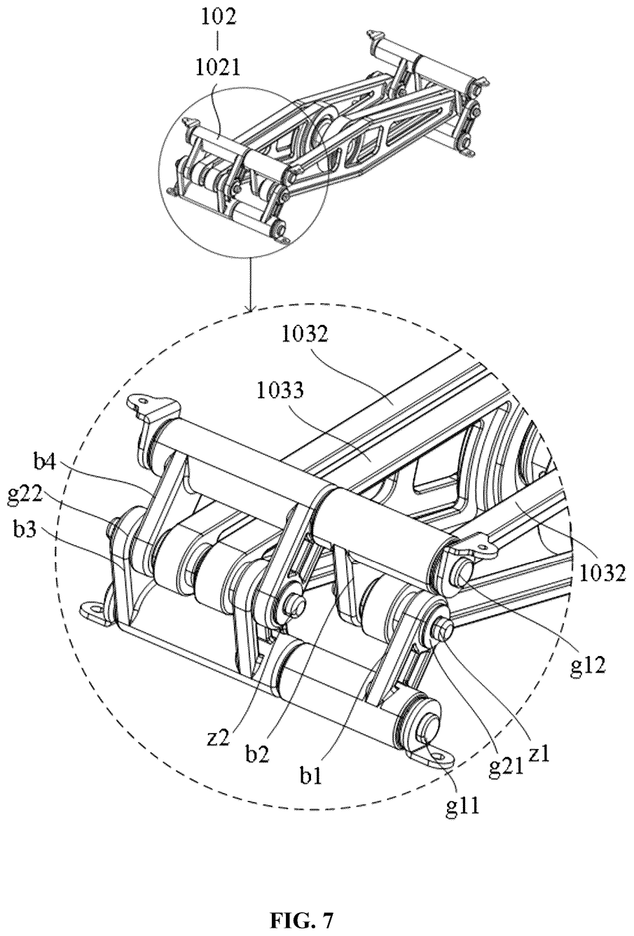

Referring to FIG. 6 and FIG. 7, FIG. 7 is a schematic diagram of a connection structure of a rocker lifting mechanism 1021 according to an embodiment of the present disclosure. In an optional implementation, any rocker lifting mechanism 1021 can include a first rotating shaft z1, a second rotating shaft z2, a first swing arm b1, a second swing b2 arranged opposite to the first swing arm b1, a third swing arm b3, and a fourth swing arm b4 arranged opposite to the third swing arm b3. The first swing arm b1 can be hinged to the mounting base 101; the second swing arm b2 can be hinged to the lifting base 105; one end of the first swing arm b1 facing away from the mounting base 101 and one end of the second swing arm b2 facing away from the lifting base 105 can be both hinged to the first rotating shaft z1; and the first rotating shaft z1 can be hinged to one of the two first connecting rods 1032. The third swing arm b3 can be hinged to the mounting base 101; the fourth swing arm b4 can be hinged to the lifting base 105; one end of the third swing arm b3 facing away from the mounting base 101 and one end of the fourth swing arm b4 facing away from the lifting base 105 can be both hinged to the second rotating shaft z2; the second rotating shaft z2 is hinged to the other first connecting rod 1032 and one of the two second connecting rods 1033. The first rotating shaft z1 can be connected to one first connecting rod 1032, and the second rotating shaft z2 can be connected to the first connecting rod 1032 and one second connecting rod 1033. In this way, when the driving assembly 104 drives the second connecting rod 1033 to move through the eccentric part 1031, the second connecting rod 1033 can drive the third swing arm b3 and the fourth swing arm b4 to swing through the second rotating shaft z2, and drive the first connecting rod 1032 to move through the second rotating shaft z2, so that the first connecting rod 1032 can synchronously drive the first swing arm b1 and the second swing arm b2 to swing through the first rotating shaft z1.

Exemplarily, since the second rotating shaft z2 can be connected to one first connecting rod 1032 and one second connecting rod 1033, and the first rotating shaft z1 is connected to one first connecting rod 1032, a length of the second rotating shaft z2 is greater than a length of the first rotating shaft z1. Moreover, the third swing arm b3 and the fourth swing arm b4 which are connected to the second rotating shaft z2 can each include two swing sub-arms, and the first swing arm b1 and the second swing arm b2 which are connected to the first rotating shaft z1 may each include a swing sub-arm.

Referring to FIG. 2, in an optional implementation, the lifting device 100 includes two groups of lifting assemblies 102 and two groups of transmission assemblies 103. The two groups of lifting assemblies 102 are respectively located on two sides of the driving assembly 104; the two groups of transmission assemblies 103 are respectively located on two sides of the driving assembly 104. The two groups of lifting assemblies 102 are in one-to-one correspondence to the two groups of transmission assemblies 103. The lifting assemblies 102 are hinged to the corresponding transmission assemblies 103. By the arrangement of the two groups of lifting assemblies 102 and the two groups of transmission assemblies 103, the entire structure can rise and fall more steadily and is less prone to deflection, and the supporting strength of the entire structure can be improved.

Referring to FIG. 2, in an optional implementation, the lifting device 100 can further include elastic assemblies 106. The elastic assemblies 106 can be located between the mounting base 101 and the lifting base 105, and two ends of each elastic assemblies 106 are respectively connected to the mounting base 101 and the lifting assemblies 102. In this way, the stability of the lifting base 105 during rising and falling can be improved through the elastic assemblies 106.

In summary, the embodiments of the present disclosure provide a lifting device 100, including a mounting base 101, lifting assemblies 102, transmission assemblies 103, a driving assembly 104, and a lifting base 105. The transmission assemblies 103 are located between two rocker lifting mechanisms 1021 of the lifting assemblies 102. Each transmission assembly 103 includes an eccentric part 1031, first connecting rods 1032, and second connecting rods 1033. The eccentric part 1031 is driven to rotate by the driving assembly 104. The eccentric part 1031 drives the second connecting rods 1033 to move. When the second connecting rods 1033 move, the first connecting rods 1032 are driven to move, so that positions of free ends g21 and g22 of the rocker lifting mechanisms 1021 connected to the first connecting rods 1032 and the second connecting rods 1033 change, and the lifting base 105 hinged to fixed ends g11 and g12 of the rocker lifting mechanisms 1021 rises and falls in a reciprocating manner relative to the mounting base 101. The lifting device 100 has a simple connection structure, is stable in transmission, and has low assembling difficulty.

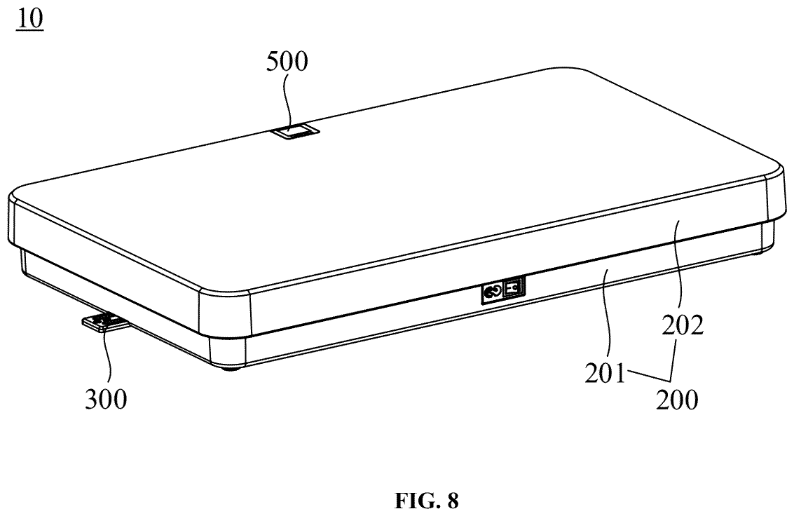

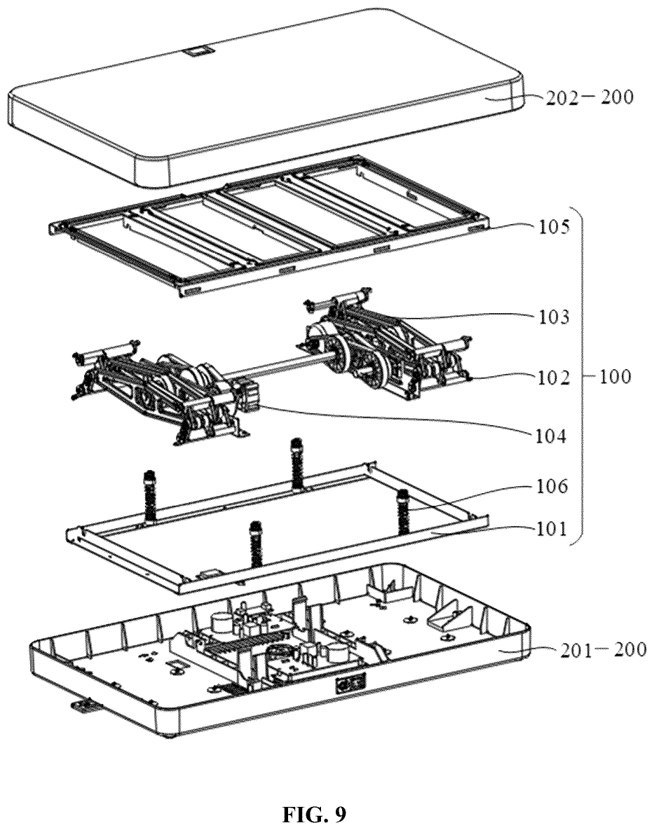

Referring to FIG. 8 and FIG. 9, FIG. 8 is a schematic structural diagram of a vibration plate 10 according to an embodiment of the present disclosure, and FIG. 9 is a schematic structural exploded view of the vibration plate 10 shown in FIG. 8. The vibration plate 10 can include an equipment housing 200 and a lifting device 100 located in the equipment housing 200. The lifting device 100 includes the lifting device 100 in any of the above embodiments.

The equipment housing 200 includes a first housing 201 and a second housing 202; the first housing 201 and the mounting base 101 are fixedly connected to each other or are of an integrated structure; and the second housing 202 and the lifting base 105 are fixedly connected to each other or are of an integrated structure. The first housing 201 can be located on one side of the second housing 202 close to the ground. A user can stand on one side of the second housing 202 facing away from the first housing 201 to do exercise. The first housing 201 can be bolted to the mounting base 101, and the second housing 202 can be bolted to the lifting base 105.

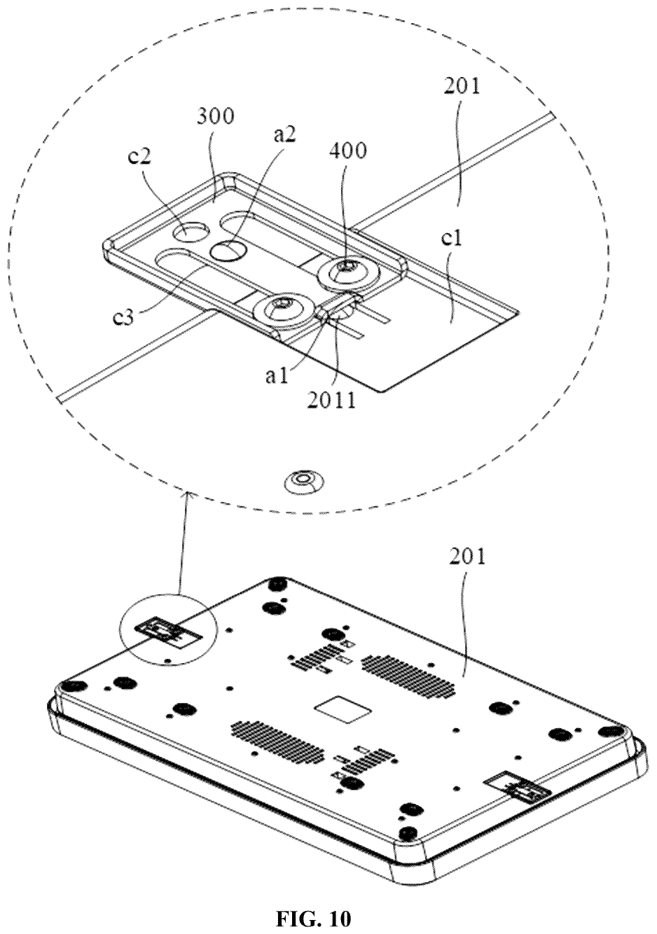

Referring to FIG. 10, FIG. 10 is a schematic structural diagram of another vibration plate 10 according to an embodiment of the present disclosure. In FIG. 10, a pull rope connecting portion 300 is in a state of extending out of a mounting slot c1. In an optional implementation, the vibration plate 10 can further include a pull rope connecting portion 300. A mounting slot c1 can be provided in one side of the first housing 201 facing away from the second housing 202. The pull rope connecting portion 300 is mounted in the mounting slot c1, and the pull rope connecting portion 300 is movably connected to the first housing 201. The pull rope connecting portion 300 can extend out of or retract into the mounting slot c1. The pull rope connecting portion 300 can be configured to connect a pull rope. When a user needs to exercise the upper limbs using a pull rope, the user can connect the pull rope to the pull rope connecting portion 300 in the state of extending out of the mounting slot c1, so as to do tension exercise when the user does exercise on the vibration plate 10. When the user does not need to use the pull rope, the pull rope connecting portion 300 can retract into the mounting slot c1 to avoid a safety hazard caused by the extending pull rope connecting portion 300 to the user, and also to beautify the overall appearance of the vibration plate 10.

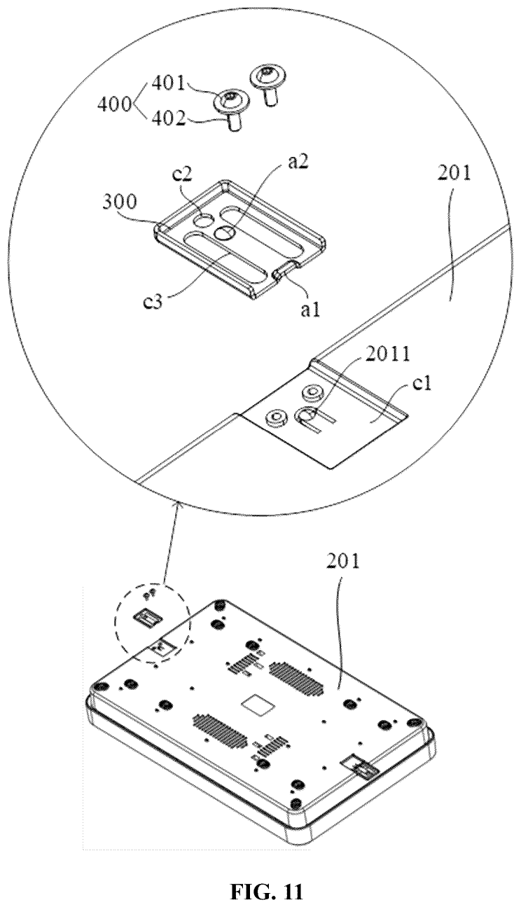

Referring to FIG. 10 and FIG. 11, FIG. 11 is a schematic structural exploded view of the vibration plate 10 shown in FIG. 10. In an optional implementation, the vibration plate 10 can further include a limiting terminal 400, and the pull rope connecting portion 300 has a connection through hole c2 and a strip-shaped limiting through hole c3. The connection through hole c2 is configured to thread the rope, and the limiting terminal 400 is arranged in the strip-shaped limiting through hole c3 in a penetrating manner, and the pull rope connecting portion 300 can extend out of or retract into the mounting slot c1 in a lengthwise direction of the strip-shaped limiting through hole c3.

The pull rope connecting portion 300 can be slidably connected to the first housing 201 through the limiting terminal 400. The limiting terminal 400 is fixedly connected to the first housing 201. The limiting terminal 400 can be matched with the strip-shaped limiting through hole c3 of the pull rope connecting portion 300, so that the pull rope connecting portion 300 can move in the lengthwise direction of the strip-shaped limiting through hole c3.

Exemplarily, there are two limiting terminals 400 and two strip-shaped limiting through holes c3, which can improve the stability of the pull rope connecting portion 300 during movement.

In an exemplary implementation, the limiting terminal 400 can include a head 401 and a screw rod 402 which are connected to each other. The screw rod 402 can be arranged in the strip-shaped limiting through hole c3 in a penetrating manner, and the screw rod 402 can be bolted to the first housing 201. The head 401 can be located on one side of the pull rope connecting portion 300 facing away from the first housing 201 to press the pull rope connecting portion 300 onto the first housing 201 through the head 401, which can improve the stability of the pull rope connecting portion 300.

Referring to FIG. 10 and FIG. 11, in an optional implementation, the first housing 201 can further have an elastic protrusion 2011 located in the mounting slot c1. The pull rope connecting portion 300 has a first groove a1 and a second groove a2. The first groove a1 and the second groove a2 are arranged in the lengthwise direction of the strip-shaped limiting through hole c3. When the pull rope connecting portion 300 extends out of the mounting slot c1, the elastic protrusion 2011 is located in the first groove a1. When the pull rope connecting portion 300 retracts into the mounting slot c1, the elastic protrusion 2011 is located in the second groove a2. After the pull rope connecting portion 300 moves to a target position, the elastic protrusion 2011 can be clamped with the first groove a1 or the second groove a2 to prevent the pull rope connecting portion 300 from moving again, which can improve the stability of the pull rope connecting portion 300.

Referring to FIG. 8, in an optional implementation, the vibration plate 10 can include a display assembly 500. The display assembly 500 can include at least one of a liquid crystal display, a light-emitting diode (LED) display, or a touch-control display.

It should be noted that in the accompanying drawings, sizes of areas may be exaggerated for the sake of clarity. Furthermore, it can be understood that when an element is referred to as being “on” another element, it can be directly on the another element, or there may be an intermediate element. In addition, it can be understood that when an element is referred to as being “below” another element, it can be directly below the another element, or there may be one or more intermediate elements. In addition, it can be understood that when an element is referred to as being “between” two elements, it can be a unique layer between the two elements, or there may be one or more intermediate elements. Similar reference numerals throughout indicate similar elements.

In the present disclosure, the terms “first”, “second”, “third”, and “fourth” are only for the purpose of description, and may not be understood as indicating or implying the relative importance. The term “plurality” means two or more, unless otherwise expressly defined.

The above describes only the optional embodiments of the present disclosure and is not intended to limit the present disclosure. Any modification, equivalent replacement, and improvement made within the spirit and scope of the present disclosure shall fall within the protection scope of the present disclosure.

What is claimed is:

1. A lifting device, comprising: a mounting base, a lifting assembly, a transmission assembly, a driving assembly, and a lifting base, wherein
the lifting assembly is mounted on the mounting base, and the lifting assembly comprises two rocker lifting mechanisms arranged oppositely;
the transmission assembly is located between the two rocker lifting mechanisms; the transmission assembly comprises an eccentric part, a first connecting rod, and a second connecting rod; two ends of the first connecting rod are respectively hinged to the two rocker lifting mechanisms; one end of the second connecting rod is connected to the eccentric part, and the other end of the second connecting rod is hinged to one of the two rocker lifting mechanisms;
the driving assembly is connected to the eccentric part;
the lifting base is connected to the lifting assembly on the side away from the mounting base;
the driving assembly drives the eccentric part to rotate; and the eccentric part drives and the lifting assembly to rise and fall through the transmission assembly, so that the lifting assembly drives the lifting base to rise and fall relative to the mounting base.

2. The lifting device according to claim 1, wherein the first connecting rod comprises a frame and a reinforcing rib; two ends of the frame are respectively hinged to the two rocker lifting mechanisms; and the reinforcing rib is fixedly connected to an inner side of the frame.

3. The lifting device according to claim 1, wherein the transmission assembly comprises two first connecting rods and two second connecting rods; the two rocker lifting mechanisms in the lifting assembly are arranged in a first direction;
the two second connecting rods are arranged oppositely in a second direction; the second direction is perpendicular to the first direction; the two second connecting rods are respectively adjacent to the two first connecting rods; and ends of the two second connecting rods away from the eccentric part are hinged to the two rocker lifting mechanisms, respectively.

4. The lifting device according to claim 3, wherein the eccentric part comprises a first cam portion, a connecting portion, and a second cam portion; the connecting portion is fixedly connected to the first cam portion and the second cam portion, respectively;
the first cam portion is hinged to one of the two second connecting rods; the second cam portion is hinged to the other second connecting rod; and
when the eccentric part rotates, a deflection displacement direction of the first cam portion is opposite to a deflection displacement direction of the second cam portion.

5. The lifting device according to claim 1, wherein any one of the rocker lifting mechanism comprises a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

6. The lifting device according to claim 2, wherein any one of the rocker lifting mechanism comprises a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

7. The lifting device according to claim 3, wherein any one of the rocker lifting mechanism comprises a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

8. The lifting device according to claim 4, wherein any one of the rocker lifting mechanism comprises a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

9. The lifting device according to claim 1, wherein the lifting device comprises two groups of lifting assemblies and two groups of transmission assemblies;
the two groups of lifting assemblies are respectively located on two sides of the driving assembly; the two groups of transmission assemblies are respectively located on two sides of the driving assembly; the two groups of lifting assemblies are in one-to-one correspondence to the two groups of transmission assemblies; and the lifting assemblies are hinged to the corresponding transmission assemblies.

10. A vibration plate, comprising an equipment housing and a lifting device located in the equipment housing, wherein the lifting device comprises the lifting device according to claim 1;
the equipment housing comprises a first housing and a second housing; the first housing and the mounting base are fixedly connected to each other or are of an integrated structure; and
the second housing and the lifting base are fixedly connected to each other or are of an integrated structure.

11. The vibration plate according to claim 10, wherein the first connecting rod comprises a frame and a reinforcing rib; two ends of the frame are respectively hinged to the two rocker lifting mechanisms; and the reinforcing rib is fixedly connected to an inner side of the frame.

12. The vibration plate according to claim 10, wherein the transmission assembly comprises two first connecting rods and two second connecting rods; the two rocker lifting mechanisms in the lifting assembly are arranged in a first direction;
the two second connecting rods are arranged oppositely in a second direction; the second direction is perpendicular to the first direction; the two second connecting rods are respectively adjacent to the two first connecting rods; and ends of the two second connecting rods away from the eccentric part are hinged to the two rocker lifting mechanisms, respectively.

13. The vibration plate according to claim 12, wherein the eccentric part comprises a first cam portion, a connecting portion, and a second cam portion; the connecting portion is fixedly connected to the first cam portion and the second cam portion, respectively;
the first cam portion is hinged to one of the two second connecting rods; the second cam portion is hinged to the other second connecting rod; and
when the eccentric part rotates, a deflection displacement direction of the first cam portion is opposite to a deflection displacement direction of the second cam portion.

14. The vibration plate according to claim 10, wherein any one of the rocker lifting mechanism comprises a first rotating shaft, a second rotating shaft, a first swing arm, a second swing arranged opposite to the first swing arm, a third swing arm, and a fourth swing arm arranged opposite to the third swing arm;
the first swing arm is hinged to the mounting base; the second swing arm is hinged to the lifting base; one end of the first swing arm facing away from the mounting base and one end of the second swing arm facing away from the lifting base are both hinged to the first rotating shaft; the first rotating shaft is hinged to one of the two first connecting rods;
the third swing arm is hinged to the mounting base; the fourth swing arm is hinged to the lifting base; one end of the third swing arm facing away from the mounting base and one end of the fourth swing arm facing away from the lifting base are both hinged to the second rotating shaft; and the second rotating shaft is hinged to the other first connecting rod and one of the two second connecting rods.

15. The vibration plate according to claim 10, wherein the lifting device comprises two groups of lifting assemblies and two groups of transmission assemblies;
the two groups of lifting assemblies are respectively located on two sides of the driving assembly; the two groups of transmission assemblies are respectively located on two sides of the driving assembly; the two groups of lifting assemblies are in one-to-one correspondence to the two groups of transmission assemblies; and the lifting assemblies are hinged to the corresponding transmission assemblies.

16. The vibration plate according to claim 10, further comprising a pull rope connecting portion; a mounting slot is arranged in one side of the first housing facing away from the second housing;
the pull rope connecting portion is mounted in the mounting slot; the pull rope connecting portion is movably connected to the first housing; and the pull rope connecting portion extends or retracts from the mounting slot.

17. The vibration plate according to claim 16, further comprising a limiting terminal, wherein the pull rope connecting portion has a connection through hole and a strip-shaped limiting through hole; the connection through hole is used for threading a pull rope;
the limiting terminal is arranged in the strip-shaped limiting through hole in a penetrating manner, and the limiting terminal is fixedly connected to the first housing; and the pull rope connecting portion extends out of or retracts into the mounting slot in a lengthwise direction of the strip-shaped limiting through hole.

18. The vibration plate according to claim 17, wherein the first housing further has an elastic protrusion located in the mounting slot;
the pull rope connecting portion has a first groove and a second groove; the first groove and the second groove are arranged in the lengthwise direction of the strip-shaped limiting through hole;
when the pull rope connecting portion extends out of the mounting slot, the elastic protrusion is located in the first groove; and when the rope connecting part retracts into the mounting slot, the elastic protrusion is located in the second groove.
